(19) United States
(12) Patent Application Publication
(10) Pub. No.: US 2022/0351109 A1
(43) Pub. Date: Nov. 3, 2022

(54) BUILDING CONSTRUCTION MANAGEMENT SYSTEM AND PROCESS

(71) Applicant: Woods Company Holdings Pty Ltd, Brisbane, Queensland (AU)

(72) Inventor: Peter WOODS, Brisbane (AU)

(21) Appl. No.: 17/633,547

(22) PCT Filed: Aug. 4, 2020
(86) PCT No.: PCT/AU2020/050801

§ 371 Date: Feb. 7, 2022

(30) Foreign Application Priority Data
Aug. 7, 2019 (AU) 2019902823

(51) Int. Cl. G06Q 10/06; G06Q 50/08; G06Q 40/00

(52) U.S. Cl. CPC G06Q 10/06313; G06Q 50/08; G06Q 10/063112; G06Q 10/06316; G06Q 40/12

(57) ABSTRACT

The disclosure is directed to a building construction management system, including a database to store associated information of one or more users There is a processor to analysis the associated information of the one or more users to selected one or more users to be associated with the building construction. The processor further generates an executable plan for the building construction and the executable plan includes tasks associated with the one or more selected users. There is also a common account to store money associated with the executable plan and the associated tasks of the one or more selected users. In use, the money can be transferred to the one or more selected users individually from the common account when the associated task is completed by the one or more selected users.

### FIELD OF DISCLOSURE

The present disclosure relates to systems and processes for management of building construction projects. The present disclosure has particular but not exclusive application in the building of houses where multiple persons are involved in the construction process.

### BACKGROUND

The building of houses and buildings usually involves a multitude of persons including architects, designers, consultants, builders, trades persons and suppliers. These stakeholders largely work in isolation and as separate business entities. While there is hierarchal line of responsibility, the trades persons are lower in the hierarchal line and will often start working without securing any payments before commencing work. The subcontractor will invoice the builder and the builder will invoice the customer. Payments are made by the customer when a certain level of work is completed. This level of work reflects a stage of building that indicates that the construction is for example, 30%, 50% or 70% complete. The invoice from the builder to the customer will not normally disclose amounts invoiced by several trades persons or suppliers that were all involved in carrying out work to the particular level of completion. The invoice to the customer from the builder is normally a total amount as an estimate of the total work completely relative to that stage. The lack of transparency of the actual works completed at that stage exposes the customer to paying more than for the work completed and leading to a possible problem of not having enough moneys (called cost to complete) should the contract with the builder be terminated, and a new builder be appointed to complete the building work.

As the builder invoices the customer relative to the stage completed, there is a lack of transparency of the direct cost from all the individual stakeholders. If the customer has an issue with one of the stakeholder's standard of work, payment by the customer of the builder's invoice could be delayed and consequently causing a delay in payment to the other stakeholders who have completed their work.

The builder of the construction project receives moneys from the customer and controls the money payable to other stakeholders lower in the building contract organisation line. The builder controls project moneys payable to other stakeholders. There is a risk to the other stakeholders where their invoices pass through the builder before they are paid.

It is normal that the builder controls around 80% of the total contract costs, being the money owed to stakeholders lower in the contractual line. Regulators of the building industry recognise this high risk and require security of the moneys held by the builder on behalf of stakeholders. This security offered by a builder can include insurance cover, bonding of moneys, providing offset assets, prepayment of monies into a trust account, personal guarantees backed by having the home of the builder being used as security, and other provisions to attempt to provide offset security provisions. This requirement is not just to protect the subcontractors but also the customer from the situation where the builder runs out of money.

The need to provide the offset security has major cost and additional management requirements over and above the direct cost of building and is passed into the final contract price. These additional costs that do not contribute to the direct cost of construction can range between 5%-10% of the contact cost.

The building industry also suffers from lack of transparency not just at the funding level, but also in the assembly of the required parties needed to construct the building. Traditionally it is not until the design by the architect or designer is completed that the required stakeholders and builder become involved. The time given to submit a tender price to the customer after design completion, is generally a few weeks, and such short time for each stakeholder to submit a quotation to the builder for their scope of works generally does not allow a quotation to be prepared correctly thus leads to the builder making guesstimates to form a tender price.

### SUMMARY

It is an object of the present disclosure to provide an alternate building management system and method to address one or more of the abovementioned problems.

According to one aspect of the present invention, there is a building construction management system, including:

a database to store associated information of one or more users;

a processor to analyse the associated information of the one or more users to select one or more users to be associated with the building construction; said processor further generates an executable plan for the building construction, said executable plan includes tasks associated with the one or more selected users; and

a common account to store money associated with the executable plan and the associated tasks of the one or more selected users,

wherein in use, the money can be transferred to the one or more selected users individually from the common account when the associated task is completed by the one or more selected users.

Preferably the one or more users include at least one or more trades persons and suppliers, one or more architects and designers, and/or one or more consultants.

Preferably the associated information of the one or more users includes working area, service type, initial price, charge rate, and/or performance history of the one or more users.

Preferably the database is a cloud-based database, wherein the associated information of the one or more users is uploaded to the cloud database.

Preferably the common account is a Joint Security Account (JSA).

Preferably the system further includes a construction manager (builder) module, said construction manager module controls the building construction plan, and said construction manager controls access to the building construction management system of the one or more users.

Preferably the system further includes a custom module, said custom module determines the building construction plan and transfers the money to the one or more users from the common account when the associated task is completed by the one or more selected users.

Preferably the construction manager module controls access to the building construction management system of the customer.

Preferably an algorithm is provided for differentiating the one or more users by the performance history, wherein the algorithm is processed to determine the one or more selected users for the building construction.

Preferably the algorithm includes ranking of the one or more users, said ranking is determined by the performance history of the one or more users.

Preferably a user is selected if the associated information of the user matches the customer's requirement.

Preferably the system further includes a supervision module, said supervision module supervise the completion of the tasks associated with the one or more selected users.

Preferably the supervision module uses light icons to indicate the status of tasks being performed by the one or more selected users.

Preferably the system further includes a profitability module, said profitability module generates profitability reports to the one or more selected users.

According to another aspect of the present invention, there is a building construction management method, including the steps of:

receiving associated information of one or more users;

determining one or more selected users from the one or more users to be associated with the building construction;

generating an executable plan and tasks for the building construction associated one or more selected users;

creating a common account to store money associated with the executable plan and tasks associated with the one or more selected users; and

transferring the money to the one or more selected users individually from the common account when the associated task is completed by the one or more selected users.

Preferably the step of determining one or more selected users from the one or more users to be associated with the building construction includes a step of matching the associated information of the one or more user to a customer's requirements.

According to a further aspect of the present invention, there is a building construction management system comprising a processor coupled with a memory, the memory storing instructions executable by the processor to receive one or more building construction project related attributes from a user; select plurality of stakeholders to be associated with the building construction project based on the received one or attributes; determine progress related to completion of a task associated with each of the plurality of stakeholders of the building construction project; and responsive to completion of the progress, transfer money to each of the plurality of stakeholders.

In one form, the building construction management system enables creating a virtual project network where the stakeholders along with the customers co-ordinate to achieve the project objectives.

In one form, a cloud-based platform is provided that enables various stakeholders to form a project ready network to collaborate for constructing a building project.

In one form the system facilitates to disburse online payments directly to the stakeholder's accounts from a common account on completion of the project related task.

Preferably, the common account is a Joint Security Account (JSA).

In one form, the customer can make appropriate payments to the trades persons and suppliers from the JSA.

In one form, the one or more stakeholders are ranked based on respective performance related to project deliverables based on project requirements.

Preferably, the rank is determined by measurements taken from a database for maintaining time frames for an activity.

Preferably, an algorithm is provided for differentiating the stakeholders based on the services provided, where an algorithm is processed to select the right stakeholder for the project.

Preferably, the rank is provided on a scale of 1 to 5.

Preferably, the rank of 3, 4 or 5 means that the stakeholders is ahead of his schedule of delivering the project

Preferably, the rank of 1 or 2 means that the stakeholder is behind of his schedule of delivering the project.

Preferably, a new stakeholder is given a ranking of 5.

Preferably, each of the stakeholders is periodically informed of his rankings so as to enable him to address relevant issues for improving performance.

In one form the builder has ultimate control over the system.

In one form the stakeholders and the customers can in collaboration determine pricing for the project prior to project initiation based on the determined customers unit requirements for the project.

In one form the stages and components of the system are trained using an artificial intelligence technique.

In one form the customer's requirements are matched to the associated data tags of information of the stakeholders.

In one form the site supervision component can use specific light icons to give a one glance status of all activities being performed in the system.

Preferably, a green light icon indicates that all the project requirements are complied with.

Preferably, a yellow light icon indicates that an action is required or pending on the project.

Preferably, a red light icon indicates that an immediate attention on the project is required.

In one form, upon the green light icon being displayed a payment claim is created for the customer to approve actual transfer of the payment from the JSA money to the corresponding stakeholder.

In one form, trades persons and suppliers, and the builders submit a final tender with complete transparency to the customer with intent to enter a project construction contract.

According to another aspect of the present invention, there is a building construction management method comprising receiving, by one more processors, one or more building construction project related attributes from a user; selecting, by the one or more processors, plurality of stakeholders to be associated with the building construction project based on the received one or attributes; determining, by the one or more processors, progress related to completion of a task associated with each of the plurality of stakeholders of the building construction project; and responsive to completion of the progress, transferring, by the one or more processors, money to each of the plurality of stakeholders.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which show embodiments of the invention and wherein:

FIGS. 1A-B show implementation of a building construction management system and the associated units according to at least one embodiment of the present invention.

FIG. 2A shows a general workflow for configuring the stakeholder's unit and the customers units for achieving objectives of the building construction management system.

FIG. 2B shows an exemplary representation of the tags associated with the stakeholders of the building construction management system.

FIG. 2C shows an exemplary representation of an assembly of a virtual team of the stakeholder's unit and the customers of the building construction management system.

FIG. 3 shows a project flow of stages and interaction amongst the stakeholder's unit to build a complete project according to at least one embodiment of the present invention.

FIG. 4 shows an onsite flow of the project trade and payments management from a joint security account according to at least one embodiment of the present invention.

FIG. 5 shows a login interface for each stakeholder.

FIG. 6 shows a flow diagram of the building construction management system.

### DETAILED DESCRIPTION

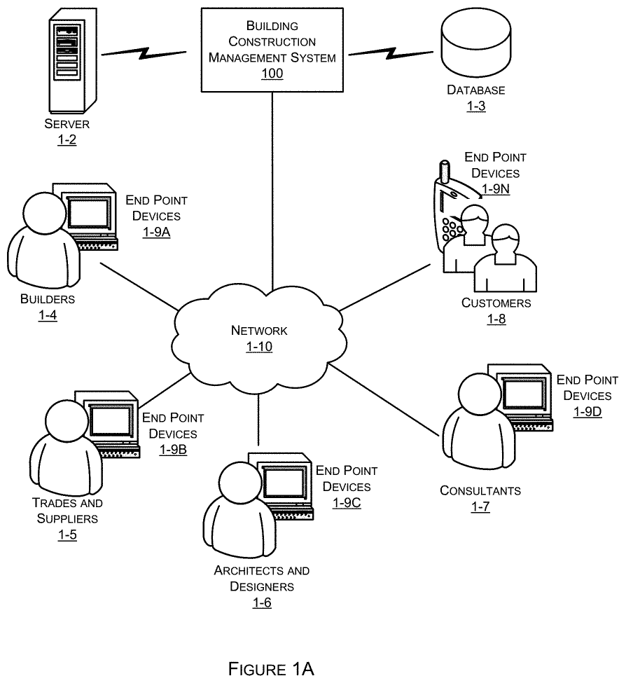

A building construction management system 100 is provided for construction projects and is shown in FIGS. 1A-B. The building construction management system 100 can be implemented using a server 1-2.

With reference to FIGS. 1A-B, the building construction management system 100 can be configured/operatively connected to a central server 1-2 and a database 1-3. While shown in FIG. 1 as a central server and a single database, it is to be understood that the central server 1-2 can have a distributed arrangement and the database 1-3 can similarly have a distributed arrangement.

The building construction management system 100 (which is referred to as system 100 hereinafter) can be communicatively configured/connected to electronic devices of various groups or entities such as construction managers 1-4, trades persons and suppliers 1-5, architects and designers 1-6, consultants 1-7 and customers 1-8, via a network 1-10 for exchange of information. The network 1-10 can be a wireless network, a wired network or a combination thereof that can be implemented as one of the different types of networks, such as Intranet, Local Area Network (LAN), Wide Area Network (WAN), Internet, and the like. Further, the network 1-10 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like.

The system 100 can include multiple units such that each unit communicates with a specific group or entity. For example, a customers unit 1-18 can communicate with multiple customers 1-8A, 1-8B, 1-8C 1-8N (collectively referred to as the customers 1-8, the customers can interchangeably be addressed as users in the further specification). Likewise, the system 100 can include a construction managers unit 1-14, trades persons and suppliers unit 1-15, architects and designers unit 1-16 and a consultants unit 1-17, which are be collectively referred to as a stakeholder's units.

The electronic devices 1-9A, 1-9B, 1-9C . . . 1-9N (collectively referred to as the devices 1-9) can be operated by each of the entity via a dedicated application running on the device 1-9. However, multiple units of the system 100 can also be accessed through a web browser running on each of the electronic devices 1-9. Further, the devices 1-9 can include, but are not limited to personal computers, smart devices, web-enabled devices, hand-held devices, laptops, mobile phones and the like, and can allow the entities to interact with the system 100 via the network 1-10.

Further, the system 100 can implement artificial intelligence by using one or more processors 1-11 that can be pre-programmed with computer readable instructions. The system 100 is a smart system and can include various machine learning trained models, deep learning models, artificial neural networks, fuzzy logic control algorithms etc. The artificial intelligence implemented by the one or more processors 1-11 and memory 1-12, the processors 1-11 can dynamically update the computer readable instructions based on various learned and trained models.

The system 100 can also include an interface(s) 1-10. The interface(s) 1-10 can include a variety of interfaces, for example, interfaces for data input and output devices, referred to as I/O devices, storage devices, and the like. The interface(s) 1-10 can facilitate communication of the system 100 with various devices coupled to the system 100. The interface(s) 1-10 can also provide a communication pathway for one or more components of the system 100. Examples of such components include, but are not limited to, processor (s) 1-11 and memory 1-12.

Embodiments of the present invention can be provided as a computer program product, which can include a machine-readable storage medium tangibly embodying thereon instructions, which can be used to program a computer (or other electronic devices) to perform a process. The machine-readable medium can include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

In another embodiment, the system 100 provides a cloud-based platform enabling various stakeholder's unit to form a project ready network to collaborate for constructing a building project and disburse payments directly to stakeholder's accounts from a common account on completion of assigned tasks.

The construction managers unit 1-14 can interact with the construction managers 1-4, which have ultimate control over building construction management. The construction managers unit 1-14 can include and enable a new customer 1-8 to become a part of the system 100. Upon receiving a request by the customer 1-8, the construction managers unit 1-14 can commence planning operations related to services to be provided for the project. The construction managers unit 1-14 can determine and provide approximate time and cost estimates as per the service requirements of the customer for the project. Also, the construction managers unit 1-14 presents scopes and quotes for the customer 1-8 as per requirement of the project. The scopes and quotes can include relevant drawings and information, estimate of quantities required, costs estimates, expected timelines, any other conditions relevant for delivery of the services for the project. The scopes and quotes can also include any certifications that can be required like related to an engineer's inspection and certificates to be provided by a concrete sub-contractor as part of their scope of work and on completion of the project.

Further, the construction managers unit 1-14 can also perform safety audits of the projects. The construction managers unit 1-14 can work along with other parties for supervising operational and developmental aspects of the project. The project supervision is done to ensure timely delivery of the construction manager's contractual obligations. Furthermore, based on a determined state of the project's progress, the construction managers unit 1-14 can provide a status indicator to activities being performed in the projects. As an example, a green indicator implies that all relevant details for the projects have been complied with and the project can be considered as done. A yellow indicator implies that an action is required or pending on the project and a red indicator implies that an immediate attention is required on the project.

The trades persons and suppliers unit 1-15 can interact with trades persons and suppliers 1-5 to provide the customers 1-8, information about available services as per the project's requirements. In addition, the trades persons and suppliers unit 1-15 can allow trades persons and suppliers 1-5 to submit a tender in accordance with requirements of the customers 1-8 related to construction of the projects. Further, the trades persons and suppliers unit 1-15 can provide different insurance policies for the undertaken projects. The details about basics of an insurance type, types of policies available, and when the policies would apply can be provided. The trades persons and suppliers unit 1-15 can determine and provide a variety of insurances and work safety standards/statements for filing into sub-contract agreements for the undertaken projects.

The architects and designers unit 1-16 facilitates providing the customers 1-9 access to recommended architects and designers 1-6 to undertake architecture/design related task. By using services of the architects and designers 1-6, the value of a building can be enhanced. Also, by using services of the architects and designers 1-6, significant savings can be obtained, especially when it comes to operating, staffing and/or tenanting the building. Further, the customers 1-8 can be given a step by step introduction of the task and their input is valued and translated into design. The customers 1-8 can have full visibility to activities of the architects and the designers 1-6. Details related to the architect/design such a photo or a design can be shared with the customers 1-8. The customers 1-8 can also share the timelines to be adhered to by the architects and designers 1-6. The customers 1-8 can share their project requirements with the architects and designers 1-6 related to but limited to the building information, budget information, and requirement of drawings/sketches.

In an embodiment the construction managers 1-4, and the trades persons and suppliers 1-5 can also provide their expertise services and can help the architects and designers 1-6 to deliver a more efficient, cost effective outcome. Further, designers can normally include consultants such as structural engineers and the like. The interaction of the customers 1-8 with the architects and designers 1-6 helps decide requirements of the design process and thereby determine cost and requirements for the project.

In an exemplary embodiment, recommendation for the architects and designers 1-6 can be determined by measurements taken from such as maintaining time frames for undertaking of an activity. The scheduled activity to be performed by the architects and designers 1-6 can be monitored and a corresponding report for the same can be prepared. Based on the report a rank can be applied based on parameter such as time—where on a scale of 1 to 5, a rank of 3, 4 or 5 means that the architect and designer is ahead of his schedule of delivering the project, while a rank of 1 or 2 means that the architect and designer is behind of his schedule of delivering the project. Also, a new stakeholder can be given a ranking of 5. The architects and designers 1-6 can be periodically informed of their rankings so as to enable them to address the relevant issues for improving their performance.

The consultants unit 1-17 broadly interacts with consultants 1-7 such as structural engineers, building certifiers and the like, all considered to be experts in their field. The consultants 1-7 can even be responsible for completely unrelated, circumstantial dependencies, such as legislative framework. For example, introduction of changes to construction regulations can have a very significant impact on the project and yet are entirely beyond control of the project's team. Further, the consultants 1-7 interacting with the consultants unit 1-17 can act as an extension of internal resources of the project's team and can streamline the project's execution. Further, established and experienced consultants 1-7 can apply knowledge, understanding of the industry, and experience from past projects in order to implement cost-saving strategies into the project. With recent and relevant experience, the consultants 1-7 can provide out of box ideas and industry best practices thereby saving time and money through life of the project.

In an embodiment, each of the stakeholder's units has data to be presented to the user for creating a customized project. The data can be presented in form of tags and the tags uniquely represent each of the stakeholder's unit. The tags can include parameters like regions of operation, types of services provided, cost schedules/rates, administration information that can be required for delivery of services and the likes.

The customers unit 1-18 can interact with multiple users that act as customers 1-8 for the system 100. The customers 1-8 can request for customization of the project and hence to keep pace with the changing needs of construction market, construction firms must develop efficient means of gathering and using knowledge and requirements of the customers 1-8. The needs, requirements, and expectations of the customers 1-8 should be understood in order to create value. For this, information about what the customers 1-8 wish their future living project is to be like and where and how would they like the project to be constructed with attributes like but not limited to construction material, use of glasses, open area, types of wood, interiors and the like should be known to the system. The customers 1-8 can have a virtual assembly of each of the required stakeholder's unit contributing into the project. The stakeholder's units can provide required set of services to the customers 1-8 based on the customer's requirements. Each stakeholder can be associated with the customer 1-8 based on matching of the customer's requirements for the project to the associated data tags of the stakeholder.

In another embodiment, the construction managers unit 1-14, the trades persons and suppliers unit 1-15, the architects and designers unit 1-16, the consultants unit 1-17, and the customers unit 1-18 can each provide end to end digital platforms. These units can handle an end-to-end business process that is necessary to achieve the projects objectives. The benefit of these units being that the digital platforms enable each of the units to undertake a function that is required for the project from lead to handover. This is especially beneficial when these units work in collaboration for achieving objectives of the projects.

In an embodiment, the construction managers 1-4, the trades persons and suppliers 1-5, the architects and designers 1-6, the consultant 1-7, and the customers 1-8 are collectively referred to herein as the stakeholders.

In yet another embodiment, an action under one of the stakeholder's unit can populate components of the other stakeholder's unit. This is done by applying algorithms and data matching for each of the stakeholder's unit. Also, data can be populated for the customer based on matching of the customer's requirements to the data tags of the relevant units of the stakeholder's unit.

As is understood the system 100 can fully or partially be implemented in other computing devices operatively coupled with a network 1-10 such as the devices 1-9 with minor modifications, without departing from the scope of the present disclosure.

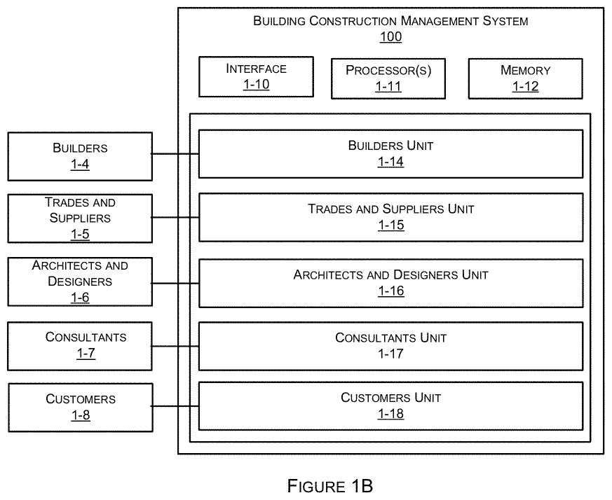

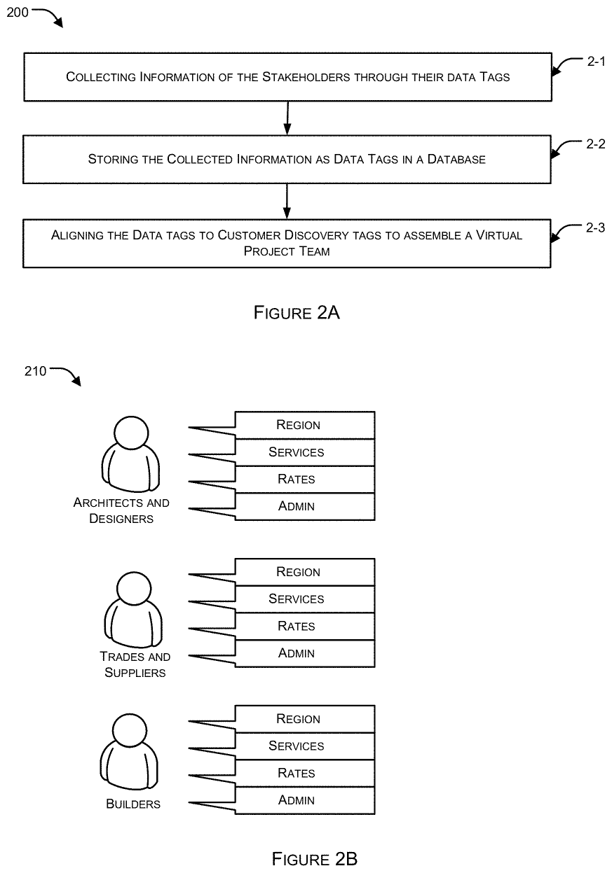

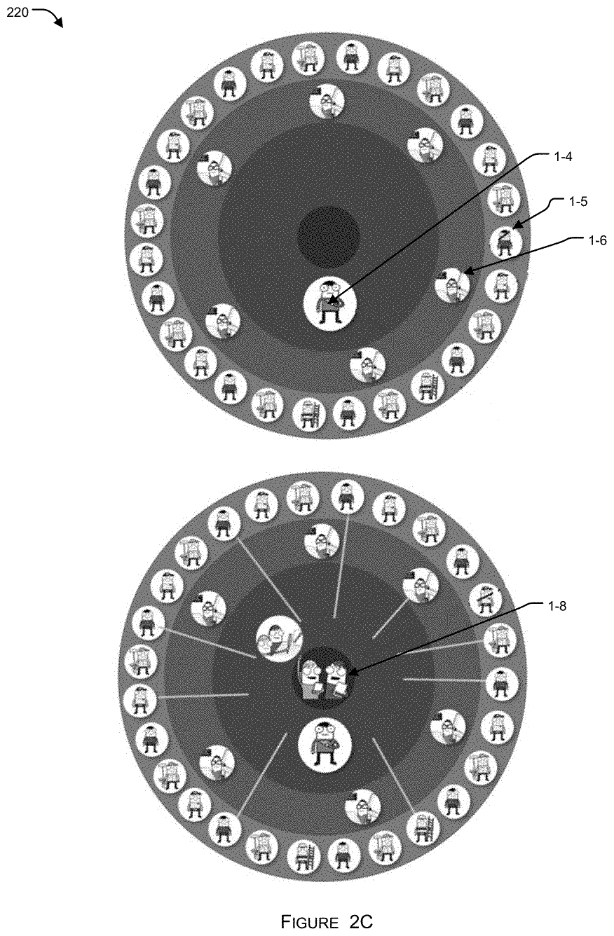

With reference to FIG. 2A, a general workflow 200 for configuring the stakeholder's unit and the customers units for achieving objectives of the building construction management system is described.

At 2-1, information of the stakeholders is collected, through each unit, in terms of their represented tags.

At 2-2, the collected information in the form of represented tags is stored in the database 1-3 of the building construction management system 100.

At 2-3, the customer requests access to the building construction management system 100. Based on the customer's request the customer is associated with one or more of appropriate stakeholders. The association of the user and the one or more of the stakeholders is done based on mapping the customer's requests with the tags associated with the information. The mapping brings the customer closer to the required one or more stakeholders and provides the customer with required and requested information for construction of the project. Further, the mapping helps to assemble a team for completion of the project as per the user's requirements.

With reference to FIG. 2B, an exemplary representation 210 of the tags associated with the stakeholders of the building construction management system of at least one embodiment of the present invention is showed.

As showed, each of the stakeholders has certain associated tags. The tags can be represented based on parameters like regions of operation, types of services provided, cost schedules/rates, administration information, that can be required for delivery of services and the likes.

With reference to FIG. 2C, an exemplary representation 220 of an assembly of a virtual team of the stakeholders and the customers of the building construction management system of at least one embodiment of the present invention is showed.

As showed each stakeholder (e.g. 1-4, 1-5 and 1-6) is assembled passively ready for engagement with the customer 1-8. The customer 1-8 is present at the centre in effect to start assembly of the virtual project team for achieving targets of the building construction management system.

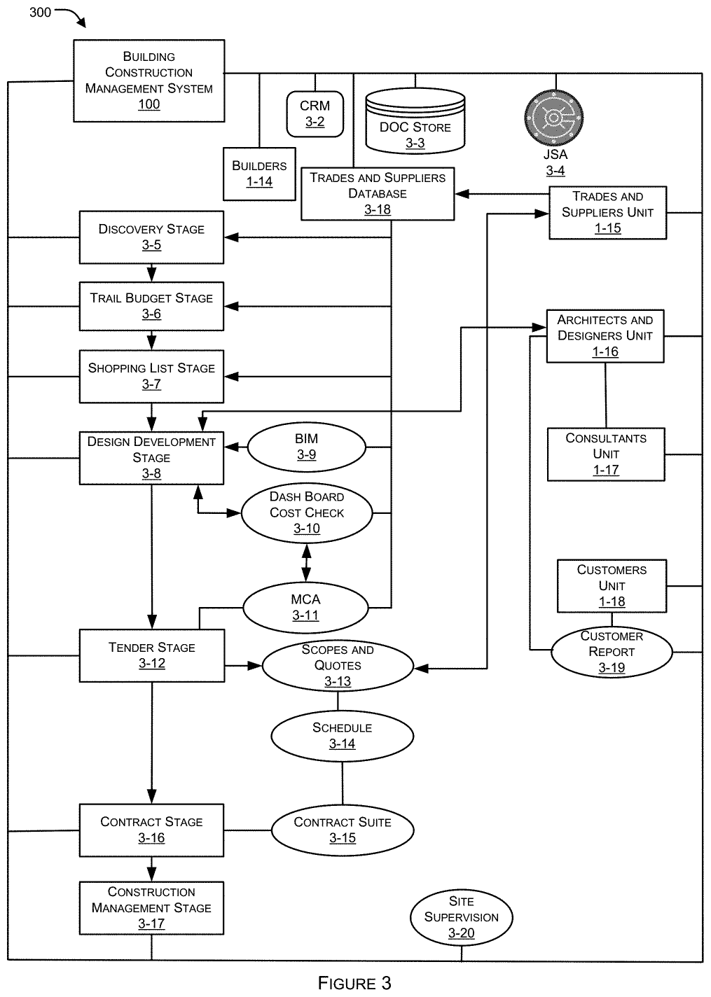

With reference to FIG. 3, a project flow 300 of stages and interaction amongst the stakeholder's unit to build a complete project is showed.

The building construction management system 100 includes multiple supporting components such as but limited to a Customer Relationship Management (CRM) component 3-2, a doc store component 3-3, and a Joint Security Account (JSA) component 3-4. Further, the system 100 includes the multiple stakeholder's units described above. Also, showed are various stages that the customer goes through while being engaged with the system 100.

In an embodiment, the various stages that the customer goes through are such as but not limited to a discovery stage 3-5, a trial budget stage 3-6, a shopping list stage 3-7, a design development stage 3-8, a tender stage 3-12, a contract stage 3-16, a construction management stage 3-17. The design development stage 3-8 is supported by a set of additional components such as but limited to a Building Information data (BIM) component 3-9, a dashboard cost check component 3-10, and a Master Cost Assembly component (MCA) 3-11. Further, the tender stage 3-12 is supported by a set of additional components such as but limited to a scopes and quotes component 3-13, a schedule component 3-14, and a contract suite component 3-15.

According to the workflow 300, the construction managers unit 1-14, the trades persons and suppliers unit 1-15, the architects and designers unit 1-16, the consultants unit 1-17, and the customers unit 1-18 is connected to various stages for providing the user's relevant services at appropriate stages of the construction project management system 100. Also, as shown the customers unit 1-18 is supported by a customer reports component 3-19. Also as shown the trades persons and suppliers unit 1-15 is supported by a profitability report component 3-21.

In an embodiment, the entire flow of the stages along with the related and connected components and in support of the connected units performs project construction and completion for the user. Further, the entire flow 300 is supervised using a site supervision component 3-20. The site supervision component 3-20 only manages the construction phase post contract signing and is further managed as a sub-component of the Building Construction Management system 100.

The above mentioned number of units, the stages and the components of the system 100 as shown in the flow 300 are not exhaustive and can be altered or added to as needed. This can be done to provide additional customized services to the customers and/or to match the project specific needs of the customer. As an example, additional units such as that for an interior designer or that for a financial provision can be provided on the customer's demand.

Many of elements of the units, the stages and the components described here in this specification can be implemented as a hardware circuit comprising custom VLSI circuits or gate arrays, off-the-shelf semiconductors such as logic chips, transistors, or other discrete components. The units, the stages and the components can also be implemented in programmable hardware devices such as field programmable gate arrays, programmable array logic, programmable logic devices or the like. The units, the stages and the components can also be implemented in software for execution by various types of processors. An identified unit of executable code can, for instance, comprise one or more physical or logical blocks of computer instructions which can, for instance, be organized as an object, procedure, or function. Nevertheless, the executables of an identified unit need not be physically located together, but can comprise disparate instructions stored in different locations which, when joined logically together, comprise the module and achieve the stated purpose for the module.

The flow 300 can be presented in an interface or a graphical user interface (GUI) for the customers and the stakeholder's unit to access. Each unit of the stakeholder's unit populate information in various provided stages and components in the flow based on the customer's requirements. Each of the presented stages, units and components can be trained using an artificial intelligence system, a support vector machine, a decision tree or a combination thereof. The customer requirements can be mapped to available units of the stakeholder's unit so as to present the information to the customers via a virtual assistant that can be configured for input or output operation (e.g., receive and/or respond in audio or speech, text, touch, gesture, etc.), communication in multi-languages (e.g., receive and/or respond according to any type of human language), and other types of input/output or communication. This leads to providing an improved interactive system over traditionally available system.

In an exemplary embodiment, the customer at the discovery stage 3-5 can be looking for a preferable room size say for an ensuite. Based on the provided inputs by the customer, one or more corresponding tags of the information of stakeholder's unit can be evaluated and a virtual assistant representative of the most appropriate stakeholder can be displayed for assisting the customer. Further, based on the customer's selections for type of fixtures such as a requirement of a double sized shower stall, a large spa, double basin vanity, and a toilet, the virtual assistant can suggest a size needed to accommodate the suggested fixtures by the customer, in the same manner as can be presented by an architect when present in person for the user.

Upon a new customer approaching the construction manager for services, the construction managers unit 1-14 can add the new customer under the customers unit 1-18. When the customer is added to the customers unit 1-18, the customer can henceforth access the system 100 and interact with other available connected units, stakeholders and components of the system 100. The customer of the customers unit 1-18 when becomes live can access the system 100 and interact with other available connected units, stakeholders and components of the system 100.

Embodiments of the invention can further be described in terms of the various stages that the customer undergoes from requesting the project's requirements to the project's completion.

### Discovery Stage 3-5 and Trial Budget Stage 3-6:

A customer can access the construction managers unit 1-14 of the system 100 in situations such as but not limited to where the user has plans for construction of the project or the customer has to obtain plans for construction of the project. In both the cases the system 100 diverts the user to the discovery stage 3-5 and the trial budget stage 3-6.

Based on whether the customer has plans for construction of the project or the customer needs to obtain plans for construction of the project, the discovery stage at 3-5 presents various project related templates such as related to: a new building structure, a renovation of an existing building structure, renovation of the structures with new area added, and renovation with no new area added. The structures here can be related but not limited to office buildings, retailers and restaurants buildings, industrial buildings, residential real estate buildings, and commercial real estate buildings.

The discovery stage 3-5 and the trial budget stage 3-6 can enable the customers to form a scope of requirements for the project and budgetary details for the project before actually engaging in initiation of the project work.

One example in this scenario is of the customer approaching the system 100 for renovation of an existing property. When the customer starts his walkthrough through the discovery stage, the entire pool of units of the stakeholder's unit are activated. Based on the user's requirements the corresponding stakeholder's unit with appropriate tags start interacting with the customer. The stakeholder's can be selected on additional parameters like a region for which the customer is seeking services, the type of project etc. For this example as the request is related to renovation of the existing property, upon the customer placing his request in the discovery stage of the system 100, the system tags the customer's project requirements to the tags of information obtained by the trades persons and suppliers unit 1-15, the architects and designers unit 1-16, and the consultants unit 1-17. This can enable the stakeholders present specifically in the requested region, to provide designs related to renovations. In addition when the customer requests renovation to be of a particular style such as Hampton style, then only the stakeholders providing renovation services in the region requested by the customer and providing renovation of Hampton style are considered in the virtual team assembly and are presented for the customers to select thereafter.

Also, the customer selecting fixtures and fittings such ad tiles, tap ware, shower screens, vanity basins and other items are provided appropriate suppliers for these type of services by the trades persons and suppliers unit 1-15. The customer is further facilitated by the system 100 for providing requested information by presenting the information via the virtual assistant that can be configured for input or output operation to receive and/or respond in audio or speech, text, touch, gesture, etc. The assistant can guide the customer about a recommended room size, types of finishes by providing a virtual architect or a design based on the customer inputs. The assistant can also aid the customer by providing one or more selection activities in the discovery stage at 3-5 ranging from various stakeholder's unit such as virtual suppliers and trades persons. The assistant can also provide stair case and kitchen designs for easing the customer's selection of services for the project. This helps the customer fine tune their selections and costs under a virtual expert advice without having to actually commit the cost of actual design.

The tags for the information through the construction managers unit 1-14, the trades persons and suppliers unit 1-15, the architects and designers unit 1-16, can be in alignment with database tags present in the discovery stage 3-5. This enables easy matching of the stakeholder's to project requirements as provided at the discovery stage 3-5 by the customers. Further, if any of the stakeholder instantiates creation and provision of a new service in the system 100, a corresponding tag for the new service shall be created and attached with the corresponding stakeholder and the similar tag for the new service shall be made available at the database tags present in the discovery stage at 3-5.

Each input of the project requirement received in the discovery stage 3-5 links to the trial budget stage 3-6. At the trial budget stage 3-6 calculations for each type of the project requirements related to bill of material, labour and costs from the corresponding tagged stakeholder's is determined and is reported to the discovery stage 3-5. As an example, a request for house raise renovation for 100 square metres of the house of the user is raised in the discovery stage 3-5. The customer input request is passed to the trial budget stage 3-6. The customer request's specific to lower level costs and quantities are generated from the data base related to tagged house raising contractors from the trades persons and suppliers unit 1-15. For such cases ancillary requirements such as safety barriers from a tagged hire company can be residing in the trades persons and suppliers unit 1-15 to be presented as per the customer project requirements. Using the discovery stage 3-5 and the trial budget stage 3-6 the customer can swap in and out various levels of finishes and renovation options.

Further, one of the stakeholders is shortlisted from the stakeholder's unit so as to provide cost coverage as determined by the customer and the construction manager's choice of selecting the final stakeholder in the system 100. In an exemplary scenario, multiple stakeholders, say 5 are tagged for being suitable as per the project requirements and the rest of the stakeholders say 3 are kept as buffer resource to be used in future. Each of the 5 stakeholders are ranked amongst themselves based on parameters such as but not limited to past performances that are determined by the site supervision component 3-20. Finally, the most suitable selected stakeholders are retained as a part of the virtual project team for providing services to the user for completion of the project.

In an embodiment, ranking for example 1 to 5 can be applied to any of the stakeholder's unit. The ranking can be provided based on parameters such as activities like delivering services on time. An algorithm is used to measure track of time frames for undertaking activities as outlined under the schedule component 3-14 that is monitored with the use of the site supervision component 3-20. The site supervision component 3-20 has a report facility that can note if the stakeholder is on time, ahead of time or behind. The primary purpose of a progress against time report is to be able to make contact through the site supervision component 3-20 directly to the stakeholder through its units to manage any timing issues. Also, a ranking is applied to the stakeholder as an example, where a ranking of 5 implies on time, ranking of 1 to 2 implies behind time and the ranking of 3 to 5 implies ahead of time. The determined ranking numbers can be aggregated across various activities being undertaken by the stakeholder, and the stakeholder with the highest ranking shall be included in the virtual assembly of the project ready network, under the discovery stage 3-5 and becomes the preferred stakeholder. New stakeholders shall be given a ranking of 5. It is important to understand that the positioning of a ranked single stakeholder is for the purpose of enabling a live price to be generated in the discovery stage and next ranked stakeholders would be included in the 3-13 scopes and quotations. A further feature is that the stakeholders can be informed of their ranking to enable the addressing of any issue.

The customer requirements when determined at the discovery stage 3-5 can help determine and approximate resultant cost of the project. The trial budget stage 3-6 can then produce a final detailed trial budget report that can list transparently each of the stakeholder services, individual costs including the construction manager's project management fee. The trial budget report can provide an accurate expected final cost to enable finance feasibility ahead of the project commitment, and remove the weaknesses of guess estimates of expected project costs for the user. Further, a virtual project team can be created of the required stakeholders by the system 100. The Master Cost Assembly component (MCA) 3-11 stores details of all parties, quantities, and costs generated from the trial budget stage 3-6, and enables the information to migrate into a design development stage 3-8, and later into the tender stage 3-12. This migration of accurate costs and quantities obtained by actual trades persons and suppliers from the discovery stage 3-5 and the trial budget stage 3-6 sets up a benchmark for all onward activities. This helps achieve cost assurance and transparency for the customers even before the project design is undertaken.

### Shopping List Stage 3-7

Using the shopping list stage 3-7 the customers can directly engage with suppliers and can shop for the products/services that were chosen at the discovery stage 3-5. The trades persons and suppliers unit 1-15 can obtain the sample product and costs from the trades persons and suppliers database 3-18 and present the same to the customer at the shopping list stage based on the customer's selected project needs. For instance the customers selecting a bathroom, at a particular level of finish, for example mid-level finish, shall then be provided to choose from similar samples of products from the suppliers from the data base with like the matched level of finish, such as tapware, vanities, baths and basins.

The shopping list stage 3-7 can be accessed by the customers or any interested third parties using the customers unit 1-18. The shopping list stage 3-7 further can have budgetary controls. This stage provides a platform to the customers to co-ordinate directly with the trades persons and suppliers through the trades persons and suppliers unit 1-15. Final selections and costs can be as determined directly by the customer as the customer can work directly with the supplier. This cost related information can then be reported in the MCA component 3-11. Further, the customer's purchase list can be maintained in the customer report component 3-19 as linked to the trades persons and suppliers unit 1-15. Furthermore, the customer can make appropriate payments to the trades persons and suppliers from the Joint Security Account (JSA) component 3-4, and this saves the construction managers unit 1-14 the task to carry accounts for the trades persons and suppliers. As the customer now pays the suppliers directly under the JSA component 3-4, this provides savings to the customer through open market buying without incorporating the construction managers supply margins.

Whilst the users can have recommended suppliers and sample products preloaded into the shopping list, the user is not bound to use the recommended supplier. Should the user want to choose a new supplier for the project outside the recommendation, the trades persons and suppliers unit 1-15 lists details of the new available suppliers into the shopping list. The new list of the suppliers can then be brought into the system 100 as described above. This feature in the shopping list, can have a provision to add a new supplier. The addition of the new supplier can also be captured in the trades persons and suppliers database 3-18 and is updated subsequently and is synced to the trades persons and suppliers unit 1-15, to be used further in the system 100.

### Design Development Stage 3-8

The design development stage 3-8 also has linkage to the shopping list stage 3-7, to allow selections of products for the project to be incorporated into the product design. This link can also enable a design item to be taken into the shopping list stage 3-7, to in turn allow a supplier to provide a cost, and expertise in further development of the project by collaborating with the construction manager, the designer, and the customer through their respective units. Through the trial budget report generated from the trial budget stage 3-6, on completion of determination of prerequisites to set the project needs against a budget, the user through the customer report component 3-19 of the customers unit 1-18, receives a report and information on the recommended architects and designers that were ranked and then captured, as being most suitable for the project, under the trial budget stage 3-6.

Each of the recommended architects and designers can be accessed in a lead capacity by the customer by connecting directly though the CRM component 3-2 through the architects and designers unit 1-16 and the customers unit 1-18. After the customer chooses an architect and designer to undertake the work, the architects and designers unit 1-16 becomes live in the network. Embodiments of the invention enable the customers to play a strategic role in the design development of the project, through the customers unit 1-18. The customer has full visibility to the architects and designers activities relevant to meeting the customers design wishes through the architects and designers unit 1-16. Any supplementary information such as a photo or design idea can be shared through the doc store component (3-3), and the designer can request or share information, including design timelines with the user.

The design development stage 3-8 has a Building Information Modelling (BIM) component 3-9, dash board cost checks component 3-10, that manage the data received from the trial budget stage 3-6 and gives the designer a clear understanding of the project requirements, for design purposes and constant checking with live costs checks against design under the BIM component 3-9. The architects and designers through the architects and designers unit 1-16 has further links to the building construction management system 100, shopping list stage 3-7, trades persons and suppliers unit 1-15, consultants unit 1-17, customers report component 3-19, and the doc store component 3-3 for loading, viewing, and sharing of supplementary information. The suppliers and trades persons can have data base tags for effectively bringing their products into the design. As one example, a staircase supplier shall ensure that openings and heights match the customer's prior staircase style selected in the discovery stage 3-5. With the staircase design coming from use of the BIM components, after that element is taken to the drawing, a prompt again matches on the data tags and alerts the staircase supplier to check the drawings to confirm that the spaces allocated are suitable. Embodiments of the invention enable the customers to be in direct contact of the trades persons, suppliers, designers and architects thereby determining accurate costs for the project and reducing high risks of re-design and hence no additional costs for the users.

### Tender Stage 3-12

The output of the preparations done at the design development stage 3-8 can now be undertaken as input at the tender stage 3-12. The project development team can ultimately be assembled at the tender stage 3-12 and is a key step in enabling assembly of all stakeholders' information, project services and costs into the Joint Security Account (JSA) component 3-4 at contract signing, to enable the benefits of security of payment to be realised.

The tender stage can bring all the stakeholders to become personally involved in with ultimate aim for the trades persons and suppliers, and the construction manager to submit a final tender with complete transparency to the customer with an intent to enter a project construction contract. The construction managers unit 1-14 can access the MCA 3-11 from the tender stage 3-12, and can thus have full details of prior parties, quantities, and cost migrated from the trial budget stage 3-6. Further using the scopes and quotes component 3-13 from the tender stage 3-12, the construction manager can now populate online individual requests for formal quotations from the engaged trades persons and suppliers. The scopes and quotes component 3-13 includes drawing information from linked design development stage 3-8, quantities and cost estimates from the MCA component 3-11, expected time lines for project engagement from schedule component 3-14, and any conditions required to delivery of services in the project construction including any certification required, determined by consultants engaged in the project from the consultants unit 1-17. Such certification can be an engineer's inspection and certification to be provided by a concrete sub-contractor as part of their scope of works, by way of example to be brought into a condition of payment from the JSA 3-4.

In an embodiment, after the construction manager has completed the scopes and quotes component 3-13 applicable to each of the engaged trades persons and supplier, a request for a formal tender from that party can be made to the trades persons and suppliers unit 1-15. The trades person or the supplier can request further information if required through the trades persons and suppliers unit 1-15, and then submit the final tender quotation into the tender stage 3-12. The construction manager can use the design development time that can be many months to first qualify the customer using stakeholder's data base passively, and then taking control of the tendering process, to then bring accurate formal tenders into the project. This gives the customer confidence that all requirements have been properly quoted under full transparency, and all the stakeholders are at less risk of being caught out by missing or not properly quoting a project requirement. This avoids the situation where there is limited time that construction managers traditionally have to prepare a tender after drawings have been completed. With a limited time frame to prepare a tender, there is a high risk of an inaccurate tender being presented to the customer.

### Contract Stage 3-16

The contract stage 3-16 can act as a repository of all relevant information needed for compliance of a contract for the project. For example, items such as variations or change orders are undertaken in this stage. A head project contract can be created through the contract suite component 3-15, and the contract can further assemble all the stakeholders into sub-contract agreements. The stakeholders can be prepared to enter in the sub-contract agreements with respect to any changes to the tender scope. The trades persons and suppliers database 3-18, can be accessed for currency of insurances and work method safety statements for example as well for population into the sub-contract agreements.

In an embodiment, under the contract stage 3-16 the Joint Security Account (JSA) component 3-4 can be formed, with a bank. The JSA component can have data from the scopes and quotes component 3-13, the schedule component 3-14, the contract suite component 3-15, and information such as bank details from trades persons and suppliers database 3-18. The JSA component 3-4, not only discloses under full transparency, of who is to be paid, how much and when, but can be shared with any third party who can need to participate in authorisation of funding into the JSA component 3-4, such as a valuer through the valuer's use of the consultants unit 1-17. All contract information including the sub-contract agreements is provided to the customer through the customer reports component 3-19 that is linked to the contract stage 3-16.

The formation of the JSA is a key component to delivering security of payment in the delivery of a contract, as well as delivering unique benefits to all stakeholders, including the user. Construction managers can now concentrate on their core business of ensuring efficient, cost effective, high quality project delivery. Trades persons and suppliers gain cash flow and security of payment, without having to carry construction manager's accounts. The trades persons and suppliers can work with the construction managers using the JSA, thereby resulting in faster construction times. Savings are delivered to the customers of not having to carry accounts, secondary funding, released assets, lowered administration. With complete transparency of who is to be paid, how much and when under the JSA, and seeing the sub-contractor, and suppliers details, if a trades person, supplier or even the construction manager does become insolvent or unable to complete their contract obligations, the transparency of all parties and knowledge that payments have only been made for cost of work for that party to date is maintained. In this situation there can be a simple novation of the contract or a separate sub-contract for the non-complying stakeholder to allow the work to continue.

### Construction Management Stage 3-17

The site supervisor component 3-20 can play a vital role in the construction management stage 3-17. The traditional construction management programs operate under mostly from an office remote from the building site, while the system 100 can operate from the building site where most of work activities are undertaken. The actual project site can become a virtual office for the activities including enabling a payment to be made from the JSA component 3-4 to any other party.

The intent of the construction management stage 3-17 can be a direct engagement of all the stakeholders through their aligned units such that the task of completing their sub-contracted obligations can be shared to enable an eventual payment to each stakeholder from the JSA 3-4. The operation of the site supervision component 3-20 under the construction management stage 3-17, is shared across the trades persons and suppliers unit 1-15, the architects and designers unit 1-16, the consultants unit 1-17, and the customer reports component 3-19 under the customer module 1-18. The visibility of information in the construction management stage 3-17, shared across the stakeholders can be controlled by the construction managers unit 1-14 under authorisation facility in the construction management stage 3-17.

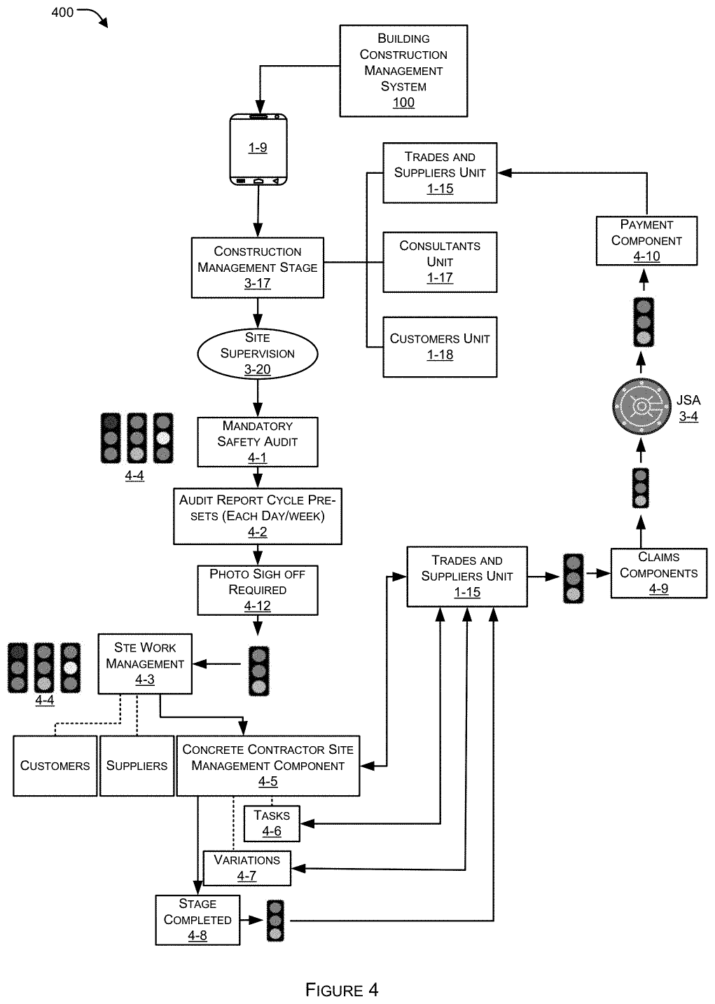

FIG. 4 shows an onsite flow 400 of the project trades persons and payments management from a joint security account.

As shown in the FIG. 4 is interaction among the various units, components, stages, stakeholders and the users for an onsite project activity that is undertaken using the site supervision component 3-20. With reference to FIG. 4, to ease collaboration in the system 100, an artificial intelligence technique is used that utilizes the databases to measure performance and progress across all activities. The performance or progress can be presented by a visual representation of a status on a home page of each party's computer terminal. The performance or progress can be represented as traffic lights with green light conveying that no attention required, orange light conveying attention required and red light signalling that there is an urgent situation to be tackled.

In an embodiment, the signal light representing the performance/progress can take the stakeholder or the customer to the corresponding component under the stages requiring attention. As an example, weather conditions can affect many issues on a building site and the system 100 can be used to inform the construction manager, the trades person and the supplier via an orange or a red light via presenting a prompt. The prompt can be displayed on the construction manager, the trades person and/or the supplier devices to warn them of an impending forecasted storm. Also, in the background the system can assess progress of activities from the site supervision component 3-20 across all networked trades persons and suppliers regarding what activities or works can be at a risk of damage, enabling pre-emptive action to be undertaken.

With reference to FIG. 4, it can be demonstrated that each process can trigger multiple outcomes, and these processes and outcomes can be monitored by visual representation of the status of each of the process. As shown, in the system 100, the trades persons and suppliers unit 1-15, the consultants unit 1-17, the customers unit 1-18, the construction management stage 3-17, the site supervisor component 3-20 are collaborated to achieve the project objective. The exemplary flow shown in FIG. 4 describes how the construction manager can visit the site and by using a corresponding remote device and use the site supervision component 3-20, to eventually enable a payment to a trades person to occur from the Joint Security Account (JSA) component 3-4. Whilst the example is around the construction manager using the site supervision component 3-20, each trades person in particular has same responsibilities for delivery of services according to their scope of work. For example the processes delivered under the site supervision component 3-20 is not limited to safety audits, and supervision tasks but are also needed for the trades person, such as working with other parties lower in the contractual chain and delivering obligations for delivery of the project. The ability for the trades person or the supplier to integrate with the construction manager and to also disperse their own site management requirements is showed under FIG. 4 as concrete contractor site management component 4-5.

The construction manager upon visiting the building site can log into the site supervision component 3-20 using the remote device. This is done to gain access to the site by entering basic information such as weather and site conditions. Before granting access to the site a mandatory safety audit 4-1 is completed, before access is allowed into the site work management program 4-3. As shown an audit report cycle presets (each day/week) 4-2 has safety items applying to the site ranked to levels of importance, to set cycle times for each item. As an example checking scaffolding can be a daily occurrence, while checking worker amenity is done at each 3rd consecutive day. A further feature is that the safety audit structure and accompanied safety plans can be provided by a third party into the audit report audit report cycle presets 4-2 by a safety consultant from the consultants unit 1-17. Based on the day of the audit item cycle, only the relevant item for that day is audited and its status is reported to the concerned stakeholders. The construction managers unit 1-14 then has the following options: 1) to sign off, that the item under supervision complies with. This is done by tagging a photo to that item such that attention is provided to the task that was needed to be completed and is completed at that time, or 2) a task is issued to a third party, also being either a trades persons or supplier accessed through a mirrored mandatory safety audit 4-1 within their site supervision component 3-20, residing in their trades persons and suppliers unit 1-15. The trades persons undertake similar safety audits as part of their obligations under their own mandatory safety audit component 4-1, also visible to the construction managers unit 1-14. For ease of operation the site supervision component 3-20, uses “traffic light icons” to give a one glance status of all activities, and not just in the safety audit 4-1, but for all other activities. As discussed above the green indicates all is complied with, yellow means an action is required or pending, and red indicates immediate attention is required. Also, the site supervision component 3-20 can be locked from further use until the red item is at least reduced to a yellow status. Clicking on the yellow or red light opens the item or items that require attention.

In an embodiment, upon the mandatory safety audit 4-1 being completed and the green light at 4-4 being activated, the site work management component 4-3 can now be available for the construction manager, or indeed the trades persons or supplier undertaking their works lower in the contract network. The site work management component 4-3 can have a list of the trades persons that should be on the site according to a particular day. As an example, the concrete contractor site management contractor 4-5 can have a notice that is not limited to scopes of works, date of being required on site, stages of works, time allocated for each stage and contract amount for each stage. Accessing information from the concrete contractor site management contractor 4-5, the site work management component 4-3 can determine on his inspection day that the concrete contractor site management contractor 4-5 should be onsite and as an example, undertaking the footing works over the next number of days as populated from the concrete contractor site management contractor 4-5.

Further, a feature of the site work management component 4-3 is that the performance standards can be rated for each of the trades persons and suppliers unit 1-15 engaged in the project to enable initial assembly of the virtual project network at the discovery stage. For example, if the concrete contractor was a no show, or if tasks 4-6 issued were to do with performance or standards of the work, these breaches can create demerit points as just one way in providing an overall ranking for all the stakeholders. As shown the construction managers 1-4 can give a green light to the activity due to having a required trade on site, on time, and with no outstanding issues. If there were tasks that were to be undertaken, the construction manager can be used to create the tasks that need attention to the concrete contractor site management contractor 4-5 and that can appear as a yellow traffic light on front page of the trades persons and suppliers module 1-15. Similarly, a yellow traffic light can be shown on the front page of the site work management component 4-3. A requirement for the concerned party to undertake the tasks can be backed up with email and SMS notification. This feature extends to the customers unit 1-18, in regards to the users needing to supply or requesting information.

In an embodiment, after the concrete contractor has reached the stage completed 4-8, for example, the construction manager then presses the stage completed 4-8 button, with a photo attachment perhaps, in the site works management component 4-3 giving literally the green light for the concrete contractor site management component 4-5 to initiate processing of an online progress claim through his claims components 4-9. Additionally, the photo sign off 4-12 of the stage can also be loaded into the JSA 3-4 component to match the preloaded contract amount against the information obtained at the contract stage 3-16 (not shown), for the concrete contractor site management component 4-5. However a yellow light indicates that there are outstanding requirements to be met by the concrete contractor site management component 4-5 before any payment from the JSA 3-4 can be made. Importantly, the customer being a co-signature for payments to be eventually made to the concrete contractor can be kept informed of the site activities through the customers unit 1-18. Such information shared by the construction manager to the customer as well as to any other stakeholder can be limited and set by component access authorizations.

In an embodiment, the processes for the claim to be processed starts with the concrete contractor accessing a claims program 4-9 within the trades persons and suppliers unit 1-15. The claims program 4-9 has pre-assembled conditions for checking off before a payment can be automatically lodged into the JSA component 3-4. Examples can be related to the stage payment amount, in this case the amount stated in the trade contract for completion of footings stage, and compliance with conditions, such as need of an engineer's inspection certificate to be loaded into the consultants unit 1-17 with an electronic receipt before a payment can be processed. Such conditions can be determined under the scopes quotes component 3-13 at the tender stage 3-12. After all the conditions are met by the concrete contractor site management component 4-5 within the claims component 4-9, including that any variations 4-7 have been approved, the green light can be activated and the claim information can be loaded into the JSA component 3-4.

Additionally, the construction manager and the customer can jointly have notification through the JSA component 3-4, when all compliance requirements for the building construction have been met by the concrete contractor site management component 4-5. Further, the claim amount matches the trade contract amount for footing stage that was preloaded into the JSA component 3-4. If there is a variation of cost loaded, this can be indicated by a yellow light initially to enable a check against any variations that can need to be processed under the site works management program 4-3 using variations feature 4-7. With the green light activated against the concrete contractor's online claim in the JSA component 3-4, the construction manager can press the green light to have the payment claim be loaded into the payment component 4-10, and the customer can finally approve actual transfer of the payment from the Joint Security Account moneys to the concrete contractor. If the customer is not satisfied, the payment can be yellow lighted and the payments can be made pending until the customer's concerns are dealt and met with. The customers can be kept informed due to customized sharing of the site information. This brings a new level of transparency and information for all contributing to security of payment for all and overall increased efficiency, lowered costs, lowered risks, and higher standards for the projects delivered.

### Online Live Profitability Report 3-21

As shown in FIG. 3, the trades persons and suppliers unit 1-15 is supported by a profitability report component 3-21. The profitability report component 3-21 provides online live profitability report to the trades persons and suppliers 1-5.

For example, a carpenter uses cost data for the activities of erecting an external timber wall frame of $25 per linear metre. The cost data is first used in the discovery stage 3-5. It is assumed 100 linear metres calculated for the project meaning a cost of $2500 is associated with the external frame erection.

As noted, 100 lineal metres may change in the design development stage 3-8 but the rate of $25 per linear metre remains constant. If it were to change the new price would carry through or the original, through to the contract stage 3-16.

In the trades persons and supplies unit 1-15, there is an allocation for the project for 100 lineal metres of external wall frame construction at a total charge out of $2500. The construction management stage 3-17 and the site supervision module 3-20 also mirrors the carpenter's allowances. The site work management 4-3 and in the example the carpenters site management component 4-5 independently monitor that at this stage the carpenters are on site and have completed the erection of the external framing and the time taken noted by both the site supervisor and the carpenter.

When the carpenter is required to do an additional amount of wall framing by way of the variation, for example there is a request for an additional 10 lineal metres of external wall frame that had not been previously allowed for, in which case a variation would be raised under the processes previously to now have a total cost of $2750. The trades persons and suppliers unit 1-15 monitors the time taken against the cost recovery. Within the trades persons and suppliers unit 1-15, the measurement of time taken against the recovery cost can deliver a profitability forecast and highlight any issues that may affect the profitability of that particular task.

As shown in FIG. 4, the carpenter's accountants using the consultants unit 1-17 can also receive live data from the construction site enabling their professional services to be engaged in a timely manner to inform the carpenter on profitability performance. There is a further ability that the accountant using the consultants unit 1-17 can also access performance data across the whole network under privacy conditions to better advise the trade in this case the carpenter on his profitability against other similar trades.

### User Interface 200

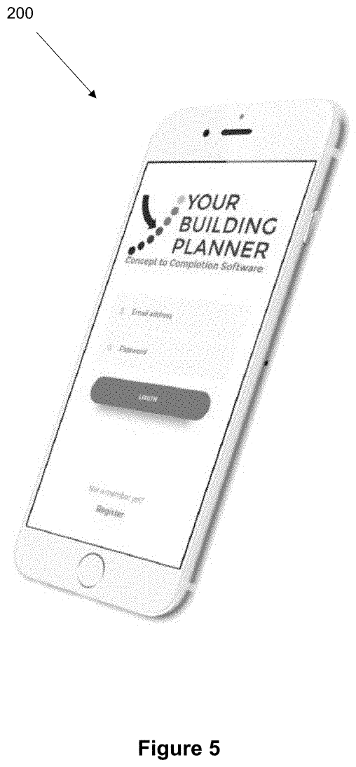

With reference to FIG. 5, there is shown a login User Interface 200 of the building construction management system 100. Each stakeholder including the construction managers, the architects and designers, the trades persons and suppliers, the consultants and the customers can register to be a new member or log in as an existing member of the building construction management system 100.

### Flow Diagram 600

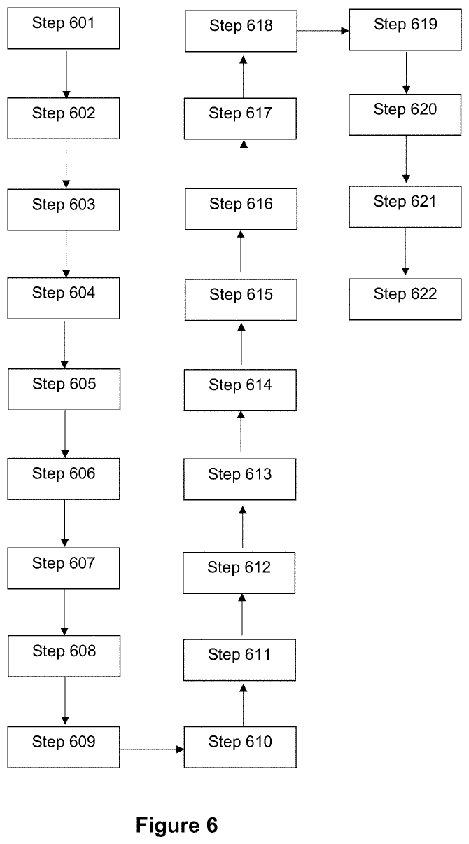

With reference to FIG. 6, there is shown a flow diagram 600 of operating the building construction management system 100 from the construction manager 1-4's perspective.

At step 601, the construction manager 1-4 accesses the building construction management system 100 through the construction managers unit 1-14.

At step 602, the CRM 3-2 sets up direct contact links to trades persons and suppliers 1-5 to invite them into the trades persons and supplies unit 1-15 based on the data that the trades persons and suppliers 1-5 provided to the database.

At step 603, the construction manager 1-4 gives permission to the customer 1-8 to access the building construction management system 100 by the customer unit 1-18. Access is gained by construction manager 1-4's invitation to the discovery stage 3-5 for the customer 1-8.

At step 604, the construction manager 1-4 uses the trial budget stage 3-6 produces a trial budget report based on the population of the discovery stage 3-5. This report is stored in the document store 3-3.

At step 605, the customer 1-8 accesses the trial budget report through the customer report 3-19 of the customers unit 1-18.

At step 606, the customer 1-8 is provided the shopping list stage 3-7. The construction manager 1-4 creates the shopping list as a process under the trial budget stage 3-6, whereas the relevant fixtures and fittings with supplier and cost allocations from the trial budget are migrated into the shopping list program.

At step 607, the customer 1-8 accesses the shopping list from the customers unit 1-18.

At step 608, the construction manager 1-4 collaborates with the architects or designers selected by the customer 1-8, through invitation of access of the architects and designers unit 1-16 to open the design development stage 3-8.

At step 609, the customer 1-8 now has access to the architects and designers unit 1-16 to enable participation in the design through the design development stage 3-8.

At step 610, the construction manager 1-4 being able to be directly involved in the design development stage 3-8 can further invite trades persons and suppliers 1-5 to input into the design by the trades persons and suppliers unit 1-15, and have the output of additional data through the building information BIM 3-9 feature populate to a dashboard cost check 3-10 to compare the original trial budget amounts with the live price calculation from the master cost assembly MCA 3-11.

At step 611, the construction manager 1-4 provides additional trial budget reports to the customer 1-8 during the design development stage 3-8 to check that any design changes stay within budget or allow a variation to be processed.

At step 612, when design is close to being finalised, the construction manager 1-4 enables the MCA 3-11 to produce a preliminary cost report to be created for the customer 1-8 as an indicative final cost before having approval by the customer 1-8 to proceed to tender stage 3-12.

The benefits to the construction manager 1-4 of being involved directly in the design development stage 3-8 ensures the construction manager 1-4 can have direct input into the design outcomes with plenty of time to enable the trades persons and suppliers unit 1-15 to be used to obtain any additional data from the trades persons and suppliers 1-5.

Further as most of the generation of the preliminary cost is done by the programs use of live data from trades persons and suppliers 1-5 integrated into the design, the construction manager 1-4 spends minimal time in keeping the customer 1-8 informed of the final cost expectation with high accuracy navigating the normal adoption of design changes.

Both the customer 1-8 and the construction manager 1-4 are able to build an enduring relationship for the final construction phase or seek to withdraw if necessary. If an alternative construction manager 1-4 is sought, the current construction manager 1-4 will transfer the previous data to a new construction manager 1-4 with a recovery cost.

At step 613, after both the customer 1-8 and the construction manager 1-4 agreed to move to the tender stage 3-12 the construction manager 1-4 commences to formalise all the data consisting of quantities and cost against each of the trades persons and suppliers 1-5 required for the contract.

At step 614, the tender stage 3-12 becomes active. The construction manager 1-4 using the scopes and quotes 3-13 assembles for each trades persons and suppliers 1-5 the requirements for their formalised based on their database schedule of rates or items of supply. The scopes and quotes 3-13 include the provisions to invite a number of suppliers and trades persons 1-5 applicable to the works needed to provide a formal quotation. This is achieved through the scopes and quotes 3-13 interfacing directly to the trades persons and suppliers unit 1-15 and such invitation based on a ranking format. If there is one specific supplier such as a kitchen manufacturer that the customer 1-8 has directly collaborated with through the shopping list and the customer 1-8 is happy to use that supplier, then only that kitchen manufacturer would be invited to formalise a quotation for the final contract.

At step 615, a schedule for the timing of the works is also created through schedule 3-14 with the expectations for each trades persons and suppliers 1-5, time of engagement within the contract is created and included in the formal request for a final quotation.

At step 616, all information is gathered into the contract suite 3-15 required information is obtained the formal contract documentation is created then the contract suite for a tender to be offered to the customer unit 1-18.

At step 617, the contract stage 3-16 manages all the activities of contract formation, including the generation online of the contract specifically, annexures, special conditions, drawings and documentation.

At step 618, trades persons and suppliers agreements are also collected and the documentation are stored in the Documentation Doc Store 3-3 and accessible by the customer 1-8 through the customers unit 1-18, construction managers 1-14 and trades persons and suppliers unit 1-15.

At step 619, after the contract is formalised the construction management stage 3-17 becomes live.

At step 620, the first task will be the creation of the joint security account JSA 3-4 with a formal request through the customers unit 1-18 to do so.

At step 621, the site supervision 3-20 becomes active to enable the day to day management of site works as described previously, including the processing of payment claims.

At step 622, consultants under consultants unit 1-17 can receive data and information to also participate in the completion of the project such as final certification, analytical reporting of profitability of trade participation and the like.

The advantage of a preferred embodiment of the present invention includes providing a building construction management system that facilitates creation of a single business platform that provides a higher security of investment, lowered costs, efficiency of product choices, and open market shopping without the construction manager's supply margins to the users.

Additionally, at least one embodiment of the present invention provides a structured approach that eases mode of operation by capturing and bringing small and medium-sized enterprises (SMEs) stakeholders of construction business and the customers under a single umbrella and paying the stakeholders securely upon completion of project tasks. Furthermore, the customer can obtain an accurate indication of the feasibility of a project before formally engaging any party by accessing live data from specific stakeholders required for the proposed project. This enables quick little to no cost qualification for both the customer and other stakeholders including the construction manager that it is worth for all parties to proceed with the most important consideration of final project cost being successfully delivered to budget.

A preferred embodiment of the present invention provides a common account for all the participating stakeholders and the customer at the time of signing the contract. The account information pertaining to the account details, subcontract amounts, payment details and other information is provided to the customer so as to enable complete transparency of which stakeholder is to be paid, how much and at which stage.

The user is guided by the system from a concept stage through to its completion stage by providing the customer's accurate cost and quantities at the project signing stage and is obtained by actual trades persons and suppliers thereby providing cost assurance and transparency to the customers.

A preferred embodiment of the invention facilitates to generate regular update regarding the progress of the project for the customers. The construction manager unit is not burdened with maintaining monies for the project and this leads to lowering the cost of administration as bookkeeping and tax obligations duties are not required to be performed.

A preferred embodiment of the invention provides a system and process for determining and providing accurate costs to the customers at the contract signing based on the specified project requirements.

A preferred embodiment of the invention provides a system and process for creating a virtual project network of all the relevant stakeholders for the project completion as per the customer's project requirements.

A preferred embodiment of the invention allows determination of the performance of the stakeholders involved in the project and rate them accordingly. Based on the provided ratings, the stakeholders are recommended for future projects.

A preferred embodiment of the invention provides a web based platform for enabling construction companies to integrate and collaborate working of the construction managers, the stakeholders and the customers and disburse online payments directly to a common joint security account for further distribution to the construction manager and the stakeholders accordingly.

A preferred embodiment of the invention provides an interactive system in the form of a virtual assistant that can receive and/or respond in form of an audio or speech, text, touch, gesture for assisting the customer in selecting services as provided by the stakeholders as per the project requirements.

A preferred embodiment of the invention provides an active system that each stakeholder can log in the construction independently and each stakeholder can be removed or replaced without affecting the existing data of a construction project.

A preferred embodiment of the invention provides an online live profitability report to the trades persons and suppliers.

It will of course be realized that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A building construction management system, comprising:
a cloud-based database to store associated information of one or more users;
a processor to analysis the associated information of the one or more users with an algorithm that ranks the one or more users by their performance history and determines a selected user from the ranked one or more users by matching them with a customer's requirements; said processor further generates an executable plan for the building construction, said executable plan includes tasks associated with the selected users; and
a common account to store money associated with the executable plan and the associated tasks of the one or more selected users,
wherein in use, the money can be transferred to each of the selected users from the common account when the associated task is completed by the respective selected user.

2. A system as claimed in claim 1, wherein the one or more users include one or more trades person and suppliers, one or more architects and designers, and/or one or more consultants and stakeholders.

3. A system as claimed in claim 1, wherein the associated information of the one or more users includes working area, service type, initial price, charge rate, and/or performance history of the one or more users.

4. A system as claimed in claim 1, wherein the common account is a Joint Security Account (JSA) wherein the customer can make payments to the trades persons, supplies and other stakeholders from the account when each task is completed; wherein online payments can be made directly to the stakeholder's accounts from the common account on completion of the project related task.

5. (canceled)

6. A system as claimed in claim 1, wherein ranking is determined by measurements taken from a database for maintaining time frames for completing a task; wherein the ranking is provided on a scale of 1 to 5 where a rank of 3, 4 or 5 means that the stakeholder is ahead of their schedule of completing the task and a rank of 1 or 2 means the stakeholder is behind in their schedule to complete the task.

7. (canceled)

8. A system as claimed in claim 1, wherein the system further includes a construction manager module, said construction manager module controls the building construction plan and controls access to the building construction management system by the one or more selected users.

9. A system as claimed in claim 1, wherein the system further includes a custom module, said custom module determines the building construction plan and transfers the money to the one or more users from the common account when the associated task is completed by the one or more selected users, wherein the construction manager module controls access to the building construction management system by the customer.

10. (canceled)

11. A system as claimed in claim 1, wherein the algorithm includes a step of ranking the one or more users based on their performance history and the selected user is chosen by matching their associated information with the customer's requirements.

12. A system as claimed in claim 1, wherein the system further includes a supervision module, said supervision module supervises the completion of the tasks associated with the one or more selected users; wherein the supervision module uses light icons to indicate the status of tasks being performed by the one or more selected users, wherein a green light icon indicates that the project requirements have been met, a yellow light icon indicates that an action is required or pending, and a red light icon indicates that an immediate action must be taken, wherein the display of the green light icon indicates that the task is completed and the payment for the completing the task is made to the relevant stakeholder from the common account.

13. (canceled)

14. (canceled)

15. (canceled)

16. A system as claimed in claim 1, wherein the system further includes a profitability module, said profitability module generates profitability reports to the one or more selected users.

17. A building construction management method, including the steps of:
receiving associated information of one or more users;
processing the associated information of the one or more users with an algorithm that ranks the one or more users by their performance history and selects a user from said one or more users that matches the customer's requirements;
generating an executable plan and tasks for the building construction associated with the one or more selected users;
creating a common account to store money associated with the executable plan and tasks associated with the one or more selected users; and
transferring the money to the one or more selected users individually from the common account when the associated task is completed by the one or more selected users.
